(19) United States
(12) Patent Application Publication
(10) Pub. No.: US 2014/0063802 A1
(43) Pub. Date: Mar. 6, 2014

(54) Optical System for LEDs for Controlling Light Utilizing Reflectors

(71) Applicant: Joseph Garcia, San Antonio, TX (US)

(72) Inventor: Joseph Garcia, San Antonio, TX (US)

(73) Assignee: KONINKLIJKE PHILIPS ELECTRONICS N.V., EINDHOVEN (NL)

(21) Appl. No.: 13/600,678

(22) Filed: Aug. 31, 2012

(51) Int. Cl. F21V 7/00

(52) U.S. Cl. CPC F21V 7/0083
USPC 362/241

(57) ABSTRACT

Methods and apparatus for an optical system for LEDs for control of light output from the LEDs. One or more optical pieces may be provided with each being over one or more LEDs and configured to direct a majority of light output from such one or more LEDs toward a desired illumination direction. A formed reflector array may be placed over the optical pieces and include openings each sized to at least partially receive one of the optical pieces and reflectors each extending upward from and provided partially over one of the openings and one of the optical pieces.

### TECHNICAL FIELD

The present invention is directed generally to an optical system for control of light output from the LEDs. More particularly, various inventive methods and apparatus disclosed herein relate to an optical system having optical pieces and reflectors utilized to control light output from a plurality of LEDs.

### BACKGROUND

Digital lighting technologies, i.e. illumination based on semiconductor light sources, such as light-emitting diodes (LEDs), offer a viable alternative to traditional fluorescent, high intensity discharge (HID), and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

In certain lighting fixtures implementing LEDs there is motivation to limit or eliminate the amount of light from the LEDs that is directed from the lighting fixture to areas that are not intended to be illuminated. Motivations to limit such stray light from LEDs may include the desire to achieve compliance with one or more standards. For example, obtaining credit for Leadership in Energy and Environmental Design (LEED) certifications requires conforming to specified spill light levels in lighting layouts. Current designs directed at limiting the amount of stray light from LEDs may significantly reduce the efficiency of light directed at the intended illumination area by blocking, and thereby wasting, light not directed in the desired illumination direction. Current designs may additionally or alternatively fail to limit stray light to the degree necessary to achieve compliance with one or more standards such as the requirements specified by LEED.

Thus, there is a need in the art to provide an optical system for LEDs for control of light output from the LEDs that optionally overcomes one or more drawbacks of some current designs.

### SUMMARY

The present disclosure is directed to inventive methods and apparatus for an optical system for LEDs for control of light output from the LEDs. For example, a plurality of optical pieces may be provided, each being over one or more LEDs and configured to direct a majority of light output from such one or more LEDs toward a desired illumination direction. A reflector array may be placed over the optical pieces. The reflector array may include a plurality of openings each sized to at least partially receive one of the optical pieces and may also include a plurality of reflectors each extending upward from one of the openings. Each reflector redirects light rays from one or more respective LEDs towards the desired illumination direction.

Generally, in one aspect, an LED optical system placeable over top of LEDs is provided and includes a plurality of optical pieces. Each of the optical pieces includes a free form LED cavity on a first side thereof and a free form protrusion on a second side thereof over the LED cavity. Each LED cavity is sized to receive at least a portion of at least one of the LEDs. Each of the optical pieces is configured to direct a first light portion of a light output received from at least one of the LEDs in a desired illumination range toward a desired illumination direction and to direct a second light portion of the light output in a stray illumination range away from the desired illumination direction. The first light portion is a majority of the light output. The LED optical system also includes a reflector array placed over the optical pieces. The reflector array includes a plurality of openings each sized to receive at least one of the optical pieces and a plurality of reflectors each extending upward from and provided partially over one of the openings. Each of the reflectors includes a reflective interior surface generally facing the desired illumination direction. Each reflective interior surface is provided partially over one of the openings opposite the desired illumination direction and reflects a majority of the second light portion of the light output transmitted from one or more corresponding optical pieces. The second light portion of the light output that is reflected by the reflective interior surface is reflected generally toward the desired illumination direction.

In some embodiments each of the reflectors is provided partially over a respective at least one of the optical pieces.

In some embodiments the reflector array is a cohesive reflector array that includes an intermediary outward facing surface extending between the plurality of openings. In some versions of those embodiments the intermediary outward facing surface of the cohesive reflector array is low reflectance and substantially black in color.

In some embodiments each of the optical pieces is configured to redirect a majority of the light output generated from a single of the LEDs received within a respective of the LED cavities in an iso-illuminance distribution pattern. In some versions of those embodiments the iso-illuminance distribution pattern includes at least one IES distribution pattern.

In some embodiments each reflective interior surface is substantially planar.

In some embodiments the LED optical system further includes a reflective layer having a reflective surface and including a plurality of openings each sized to receive at least one of the LEDs. The optical pieces are placed atop the reflective layer and the reflective layer generally faces the optical pieces.

Generally, in another aspect, an LED optical system placeable over top of LEDs is provided and includes a plurality of optical pieces each configured for placement over at least one of the LEDs generating an LED light output. The optical pieces include a first portion configured to redirect the LED light output incident thereon in a distribution pattern generally toward a desired illumination direction, and a second portion configured to redirect the LED light output incident thereon in an illumination range away from the desired illumination direction. The LED optical system also includes a plurality of reflectors, each of the reflectors extending upward from and provided partially over at least one of the optical pieces. Each of the reflectors includes a reflective interior surface generally facing a corresponding optical piece of the at least one of the optical pieces and positioned opposite the desired illumination direction. Each reflective interior surface reflects the LED light output transmitted in the illumination range from the corresponding optical piece and redirects the incident LED light output generally toward the desired illumination direction.

In some embodiments each reflective interior surface is vacuum metalized.

In some embodiments each of the reflectors is provided partially over the second portion of a respective of the at least one of the optical pieces.

In some embodiments each of the reflectors is not provided over the second portion.

In some embodiments the optical pieces form a cohesive optical array, the cohesive optical array including an optical array intermediary outward facing surface extending between the optical pieces. In some versions of those embodiments the plurality of reflectors form a cohesive reflector array, the cohesive reflector array including a plurality of openings each sized to receive at least one of the optical pieces and an intermediary outward facing surface extending between the plurality of openings.

In some embodiments the intermediary outward facing surface of the cohesive reflector array is low reflectance and substantially black in color.

Generally, in another aspect, an LED lighting unit is provided and includes at least one LED, an optical piece positioned over the LED, and at least one reflector piece placed over the optical piece. The optical piece redirects a majority of light output generated by the LED in an iso-illuminance distribution pattern generally toward a desired illumination direction and redirects a secondary portion of light output generated by the LED generally away from the desired illumination direction. The reflector piece includes an opening sized to receive the optical piece, an outward facing surface peripheral of the opening, and a reflector extending upward from and provided partially over the opening. The reflector includes a reflective interior surface generally facing the desired illumination direction. The reflective interior surface is provided partially over the opening opposite the desired illumination direction and reflects the secondary portion of light output redirected by the optical piece. The secondary portion is reflected by the reflective interior surface generally toward the desired illumination direction.

In some embodiments each reflective interior surface is vacuum metalized. In some versions of those embodiments, the outward facing surface is substantially low reflectance. In some versions of those embodiments the optical piece is part of a cohesive optical array including additional optical pieces.

In some embodiments the LED lighting unit further includes an intermediary reflective layer interposed between the LED and the optical piece. The intermediary reflective layer has a reflective surface generally facing the optical piece and includes an opening sized to receive the LED.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a lower perspective view of an embodiment of an LED lighting unit with a single piece reflector array of the LED lighting unit exploded away from a single piece array of optical pieces of the LED lighting unit.

FIG. 2 illustrates a close-up lower perspective view of a portion of the embodiment of the LED lighting unit.

FIG. 3 illustrates a section view of a portion of the embodiment of the LED lighting unit taken along the section line 3-3 of FIG. 2.

FIG. 4 illustrates a lower perspective view of another embodiment of an LED lighting unit with a single piece reflector array, a cohesive array of optical pieces, an intermediary reflective array, and an LED array exploded away from one another.

FIG. 5 illustrates a side view of the single piece reflector array of the embodiment of the LED lighting unit.

FIG. 6 illustrates another side view of the single piece reflector array of the embodiment of the LED lighting unit.

FIG. 7 illustrates a lower perspective view of a portion of an embodiment of an LED optical system.

FIG. 8 illustrates a lower perspective view of the embodiment of the LED optical system with a reflector of the LED lighting unit exploded away from an optical piece of the LED optical system.

FIG. 9 illustrates a side view of the embodiment of the LED optical system with a single reflector of the LED optical system and a single optical piece.

### DETAILED DESCRIPTION

In certain lighting fixtures implementing LEDs there is motivation to limit or eliminate stray light from the LEDs that is directed from the lighting fixture to areas that are not intended to be illuminated. Current designs directed at limiting the amount of stray light from LEDs may significantly reduce the efficiency of light directed at the intended illumination area. Thus, Applicant has recognized a need in the art to provide an optical system for LEDs for control of light output from the LEDs that limits illumination in unwanted areas and redirects light that is initially directed in an unwanted direction towards the intended illumination direction.

More generally, Applicants have recognized and appreciated that it would be beneficial to provide methods and apparatus related to an optical system having optical pieces and reflectors utilized to control light output from a plurality of LEDs.

In view of the foregoing, various embodiments and implementations of the present invention are directed to an optical system for LEDs for control of light output from the LEDs.

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the representative embodiments. Such methods and apparatus are clearly within the scope of the claimed invention. For example, aspects of the methods and apparatus disclosed herein are described in conjunction with particular distributions of LEDs on an LED board. However, one or more aspects of the methods and apparatus described herein may optionally be implemented in combination with other LED configurations (e.g., one or more LEDs in an alternative distribution mounted directly to a heatsink) and implementation of the one or more aspects of an optical system described herein in combination with alternatively configured LED configurations is contemplated without deviating from the scope or spirit of the claimed invention.

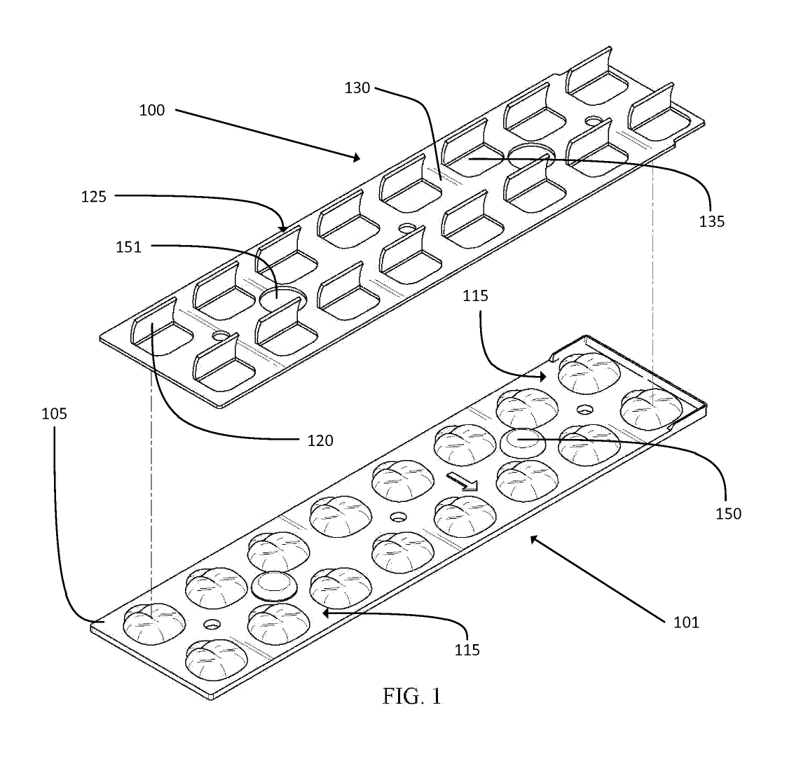

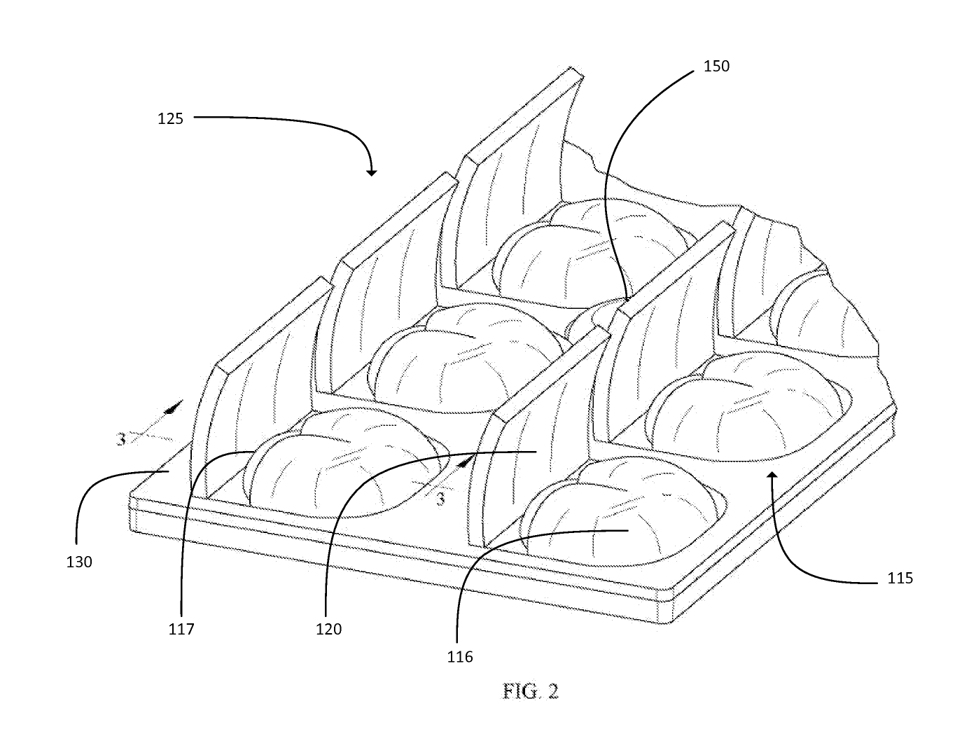

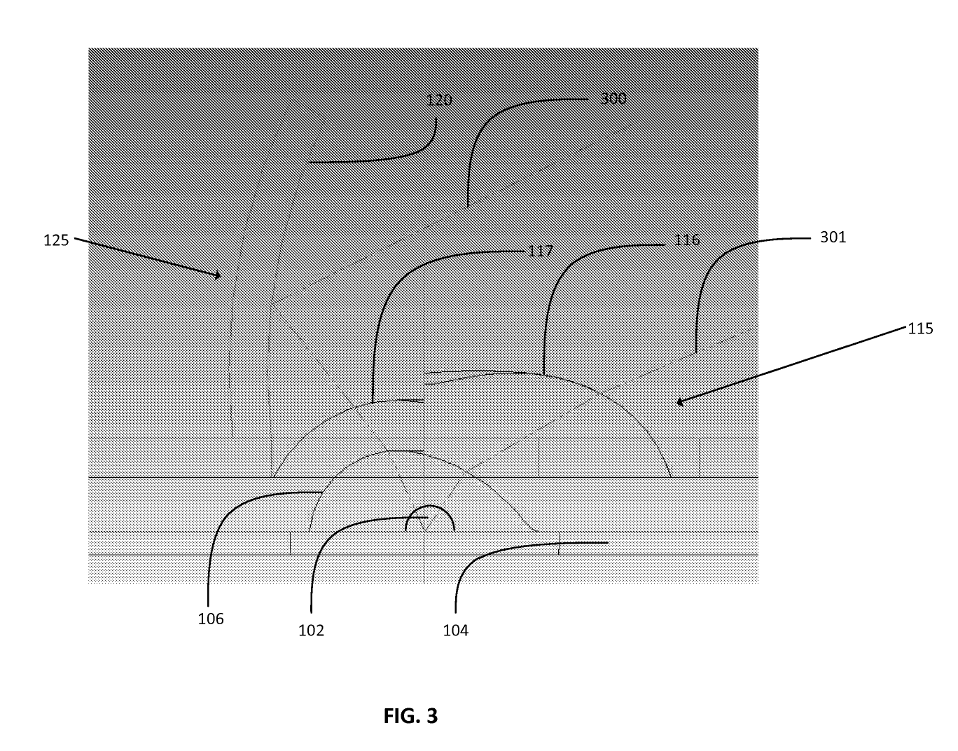

Referring to FIGS. 1 through 3, an embodiment of an LED lighting unit is illustrated. The LED lighting unit includes an array of LEDs 102 mounted on an LED circuit board 104 (FIG. 3). An optical system of the illustrated LED lighting unit includes a cohesive single piece reflector array 100 and a cohesive array of optical pieces 101. The optical array 101 includes a plurality of individual optical pieces 115 that are cohesively formed with one another so that each optical piece 115 may be positioned and aligned over a single of the LEDs 102. In some embodiments one or more of the optical pieces 115 may be separate from and not cohesively formed with other of the optical pieces. In the illustrated embodiment the optical pieces 115 each include a first portion 116 and a second portion 117 and each share a substantially common configuration. In other embodiments one or more of the optical pieces may have a configuration different than that illustrated and/or may have a configuration that is unique from other optical pieces. Each of the optical pieces 115 is also commonly oriented relative to a respective of the LEDs it is provided over so that the first portion 116 of each of the optical pieces directs light output from an LED 102 it is provided over generally in the desired illumination direction.

The individual optical pieces 115 may be designed and populated in combination with the LEDs 102 to produce any desired distribution pattern. For example, the individual optical pieces 115 may be designed to produce asymmetric full cut-off Illumination Engineering Society (IES) patterns such as IES Type II, III, and/or IV full cut-off patterns. As an example, in some embodiments each of the optical pieces 115 may produce an IES Type II pattern. Each of the optical pieces 115 includes an LED cavity 106 (FIG. 3) on an inner facing side thereof. The LED cavities 106 are each positioned and sized to surround at least a portion of a single of a respective LED 102 (e.g., at least the light emitting die and/or light emitting epoxy casing) and direct light output therefrom through a respective individual optical piece 115 provided thereover. The LED cavities 106 may optionally receive at least a portion of a respective LED 102 therein. The illustrated LED cavities 106 have a generally arcuate profile on a side (e.g., as illustrated in FIG. 3). The portion of the arcuate profile of the LED cavities 106 underlying the first portion 116 is configured to refract a majority of light output from LED 102 generally directed thereto generally in the desired illumination direction. The portion of the arcuate profile of the LED cavities 106 underlying the second portion 117 is configured to refract the majority of the remaining light input from LED 102 opposite the desired illumination direction.

The specific curvature of the outer surface for each of the individual optical pieces 115 may be selected based on a number of parameters such as the light output characteristics of LEDs 102, the spacing of LEDs 102, height constraints, the configuration of LED cavities 106, and/or desired IES distribution. The surface profile of the outer surface for each of the individual optical pieces 115 and/or of the inner surface (LED cavities 106) of the individual optical pieces 115 may optionally be designed in a ray tracing program and modified with weighting factors and multiple iterations to create the final free form shape of the optical piece 115.

The illustrated embodiment of the optical pieces 115 includes a first portion 116 and a second portion 117. Each first portion 116 directs a majority of the light from a respective of the LEDs 102 that is incident thereon generally toward the desired illumination direction. Each second portion 117 redirects a majority of light from a respective of the LEDs 102 that is incident thereon away from the illumination direction and generally toward a respective reflective interior surface 120 of the reflector 125. The first portion 116 and second portion 117 may both have a substantially arcuate outer profile with a substantially planar adjoining section that joins the first portion 116 and the second portion 117. Each second portion 117 is placed on the backside of a corresponding first portion 116 away from the illumination direction. The illustrated embodiment includes a slight recess in the outer surface of the first portion 116. The recess may be positioned to receive the most intense portion of light from a respective LED 102 and may provide for wider dispersion of the light incident therein.

Each LED 102 is positioned within the respective LED cavity 106 so that the LED 102 is primarily positioned under the first portion 116 and, optionally primarily positioned under the recess of the first portion 116. In other words, a majority of each LED 102 is positioned under a respective first portion 116 and a majority of the light output from the LED 102 may be directed into the first portion 116. The LED cavity 106 and the outer surface of the first portion 116 of the optical piece 115 are configured to cooperatively work together to direct a substantial majority of light output generated by an LED 102 generally in the desired illumination direction as illustrated by example light ray 301. The LED cavity 106 and the outer surface of the second portion 117 are configured to cooperatively work together to substantially direct other light output generated by LED 102 generally toward the reflective interior surface 120 of the respective reflector 125 as illustrated by example light ray 300 in FIG. 3. Each interior reflective surface 120 reflects light rays that have been directed thereto by the second portion 117 toward the desired illumination direction (e.g., light ray 300 in FIG. 3). The illustrated light rays in FIG. 3 are provided as an example to illustrate an example interaction between light output of an LED 102 and corresponding optical piece 115 and reflector 125 provided over the LED 102. One of ordinary skill in the art, having had the benefit of the present disclosure, will recognize and appreciate that many additional light rays will be provided and may interact with the optical piece 115 and/or the reflector 125 in a manner that is different than that illustrated by light rays 300 and 301. Moreover, one of ordinary skill in the art will recognize and appreciate that alternative interactions of light rays with the optical piece 115 and/or reflector 125 may occur.

In some implementations the LED lighting unit may be installed along the perimeter of a parking lot such that the optical pieces are oriented to direct illumination toward the parking lot while minimizing any light directed peripherally of the parking lot perimeter. Each of the first portions 116 may be positioned on a side of the LED lighting unit that is more proximal the desired illumination area than a corresponding second portion 117. Other potential implementations of lighting unit include, for example, utilization in pedestrian pathway applications to limit house side light and installation along the perimeter of a parking garage to provide substantially zero line of sight from outside the garage of light emitting from the lighting unit.

In some embodiments individual optical pieces and/or optical array 101 may be manufactured as a single piece of acrylic, optionally utilizing standard injection molding procedures. In some embodiments the optical pieces may be placed in fixed relation to one of the LEDs 102 utilizing an adhesive to attach the optical piece 115 to a surface surrounding the LED 102. In some embodiments where the optical array 101 is formed as a single acrylic piece the optical pieces 115 may be connected by an outward facing surface 105. In some embodiments the outward facing surface 105 may be translucent and, optionally manufactured from acrylic. In some embodiments the underside of the outward facing surface 105 may be in contact with the circuit board 104.

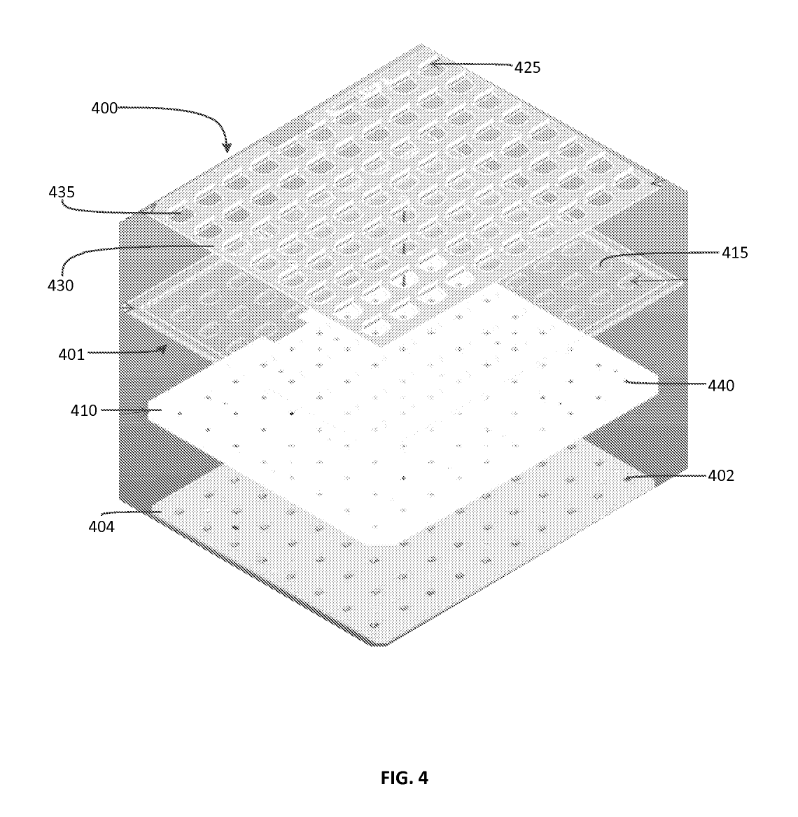

In some embodiments each optical piece 115 and/or the optical array 101 may be adhered to the circuit board 104. In some embodiments the optical array 101 may be coupled to an intermediary surface between the circuit board 104 and the optical pieces. In some embodiments the intermediary surface may be a reflective layer such as reflective layer 410 shown in FIG. 4. The LEDs 102 may be attached to a circuit board 104 in some embodiments and/or may be attached to another surface in some embodiments. For example, in some embodiments the LEDs 102 may be directly attached to a heatsink and/or an additional circuit board.

The single piece reflector array 100 is placeable over the optical array 101 and includes a plurality of openings 135. The openings 135 are each aligned with and each receive and surround one of the free form optical pieces 115. In the illustrated embodiment the optical pieces 115 extend through the openings 135. Alignment protrusions 150 on outward facing surface 105 align with respective alignment receptacles 151 on reflector array surface 130 and may optionally be utilized to achieve accurate alignment of the reflector array layer 100 and the optical array 101. The openings 135 may optionally be larger than the peripheries of the optical pieces 115 in some embodiments. In some embodiments the openings 135 may be smaller than the peripheries of the optical pieces 115 and the single piece reflector array 100 may optionally rest atop the optical pieces. In some embodiments a single interior reflective surface 120 may be utilized by two or more optical pieces 115. For example, a single reflective surface 120 may be provided partially over two optical pieces 115, may intersect stray light rays emitted by such optical pieces 115, and reflect the intersected stray light rays in a desired illumination direction. An intermediary outward facing surface 130 extends between and surrounds the openings 135. In some of those embodiments the reflector array outer surface 130 may be painted with and/or molded out of a flat black material to minimize any light reflection off the reflector array surface 130. Minimization of light reflection off the reflector array surface 130 may minimize the amount of light from LEDs 102 that is incident thereon and directed in a stray direction away from the desired illumination direction.

A plurality of reflectors 125 is provided. Each of the corresponding reflectors 125 extends upward from and is provided partially over one of the openings 135 and partially over one of the optical pieces 115. Each of the reflectors 125 has a reflective interior surface 120 that is positioned and shaped to reflect a majority of the refracted light out of second portion 117 in the direction of desired illumination. In addition, any stray light incident on the reflective interior surface 120 is reflected toward the desired illumination direction. The reflective interior surface 120 of each reflector 125 is also positioned and shaped so as to minimize interference with light emitted from the surrounding optical pieces and directed in the desired illumination direction. The interior surface 120 of each reflector 125 may be constructed of a single surface or multiple facets. In some embodiments the reflective interior surface 120 may extend at least partially over the second portion 117 (as in FIG. 3). In some embodiments the reflective interior surface 120 may optionally extend partially over the first portion 116. In some embodiments the interior reflective surface 120 may be vacuum metalized and/or painted to achieve a reflective surface. In some embodiments the reflective interior surface may be formed of a reflective material such as aluminum.

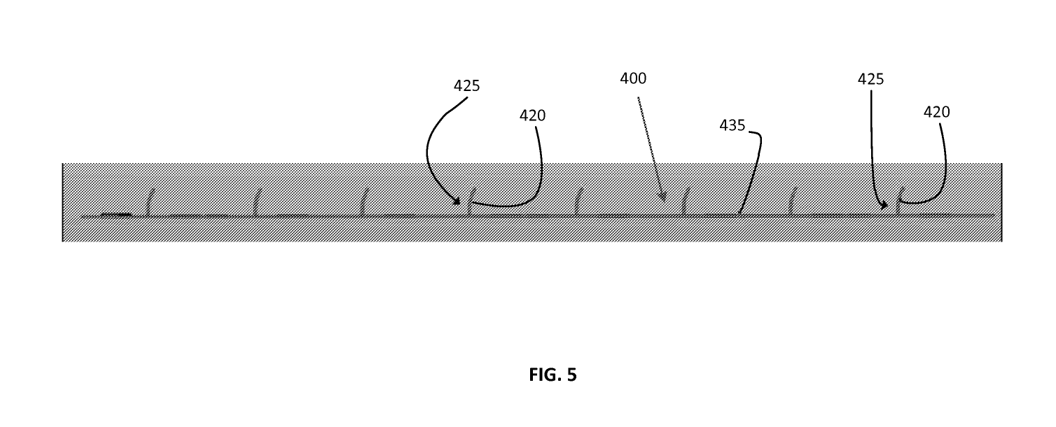

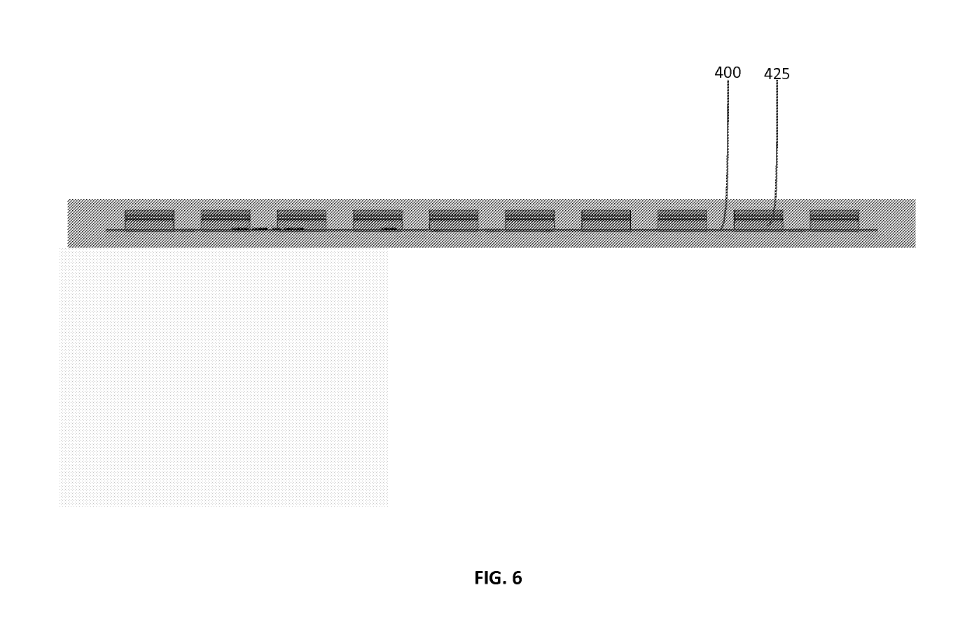

Referring to FIGS. 4 through 6, another embodiment of an LED lighting unit is illustrated. The LED lighting unit includes a single piece reflector array 400, a cohesive optical array 401, an intermediary reflecting layer 410, and a PCB board 404. The PCB board 404 supports an array of LEDs 402. The optical array 401 may share one or more common aspects with the previous described optical array 101. The optical array 401 may be a cohesive array as shown in FIG. 4 or multiple pieces (e.g., each optical piece 415 may be a separate piece). The intermediary layer 410 may optionally be reflective on at least the upward facing surface (surface facing away from 404). The intermediary reflective layer 410 may contain an array of openings 440 corresponding to the placement of the LEDs 402 on PCB board 404 to receive one or more of the LEDs 402. The intermediary reflective layer 410 may be a highly reflective laminate and may adhere to the PCB board 404 and to the optical array 401 using translucent double-sided adhesive.

The plurality of optical pieces 415 may share one or more characteristics with optical pieces 115 of the previously described embodiment. The optical pieces 415 may include a first portion and a second portion similar to the first portion 116 and second portion 117 of the embodiment illustrated in FIGS. 1 through 3. The first portion may be configured similarly to the first portion in the previously described embodiment and direct light as generally shown by example light ray 301 in FIG. 3. The optical pieces 415 may include a second portion that directs light as generally shown by example light ray 300 in FIG. 3. Each of the individual optical pieces 415 may include an LED cavity similar to LED cavity 106 of the previously described embodiment on an inner facing side thereof and be positioned and sized to surround at least a portion of a single of a respective LED 402.

Each of a plurality of reflectors 425 extends upward from and is provided near a corresponding of the openings 435 on the side of the opening 435 opposite the primary illumination direction. In the illustrated embodiment the reflectors 425 are formed as a cohesive reflector array 400 and coupled to one another via a reflector surface 430. In some embodiments the reflectors 425 may be separate pieces. Each of the reflectors 425 has a reflective interior surface 420. The reflective interior surface 420 is positioned and shaped so as to not interfere with light emitted from the surrounding optical pieces that are directed in the desired illumination direction. The illustrated reflective interior surface 420 is positioned to intersect light emitted from a corresponding optical piece 415 and reflect the light towards the desired illumination direction. The illustrated interior surface 420 is generally arcuate and oriented to reflect light incident thereon from a respective optical piece 415 toward the desired illumination direction. In some implementations the interior surface 420 may include a single arcuate face. In some implementations the interior surface 420 may include plurality of planar faces adjoining one another. In some embodiments the reflector 425 may extend at least partially over a portion of optical piece 415. In some embodiments the interior reflective interior surface 420 of the reflector 425 may be vacuum metalized and/or painted to achieve a reflective surface. In some embodiments the reflector array surface 430 of reflector array 400 may be painted with and/or molded out of a flat black material to minimize any light reflection off the outward facing surface. In some embodiments 400 is a single formed piece made from reflective aluminum such as Miro and painted flat black on the back side.

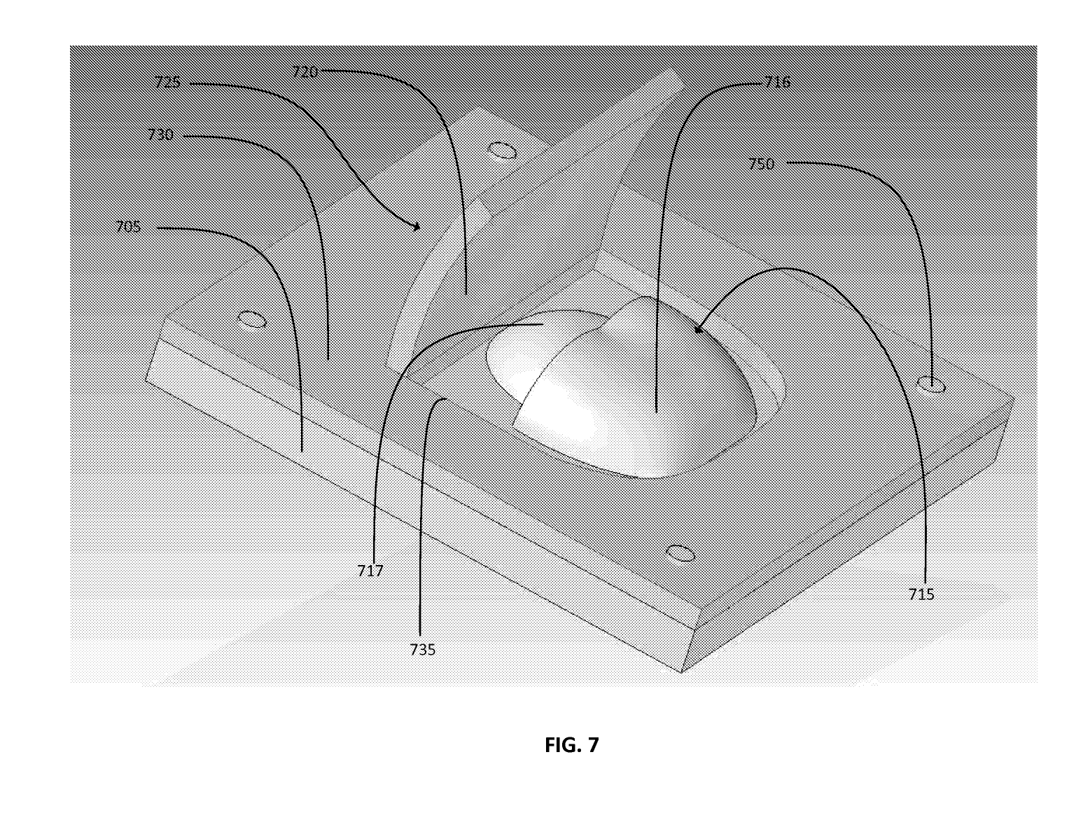

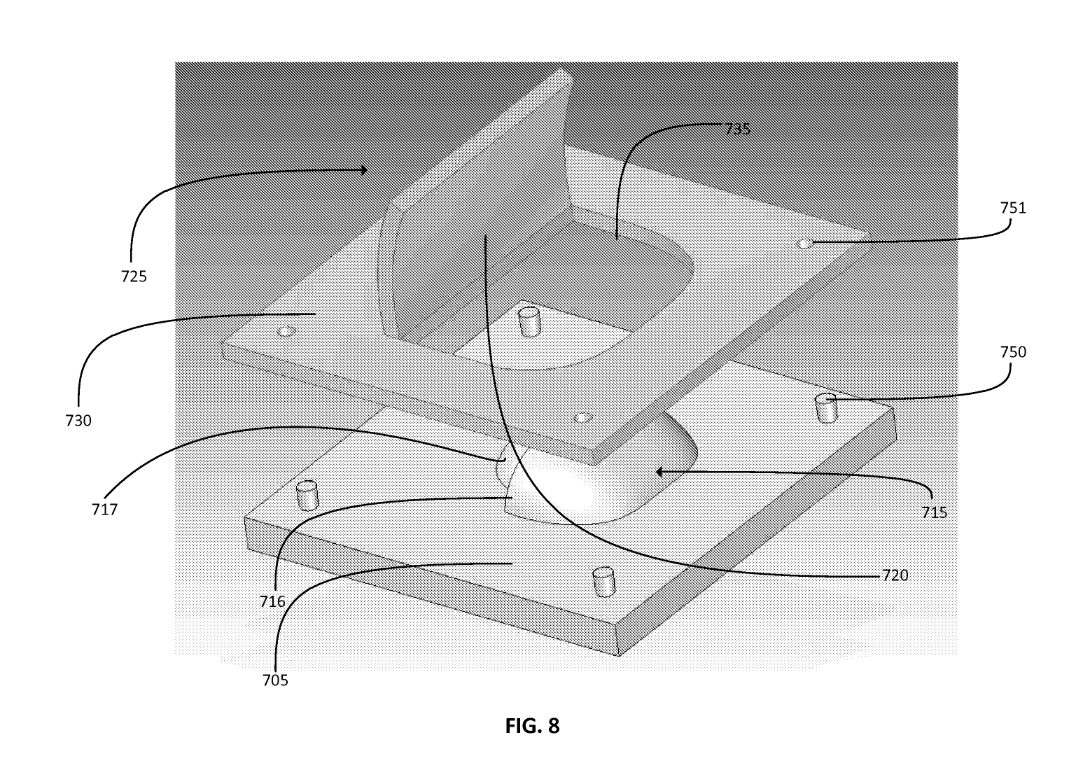

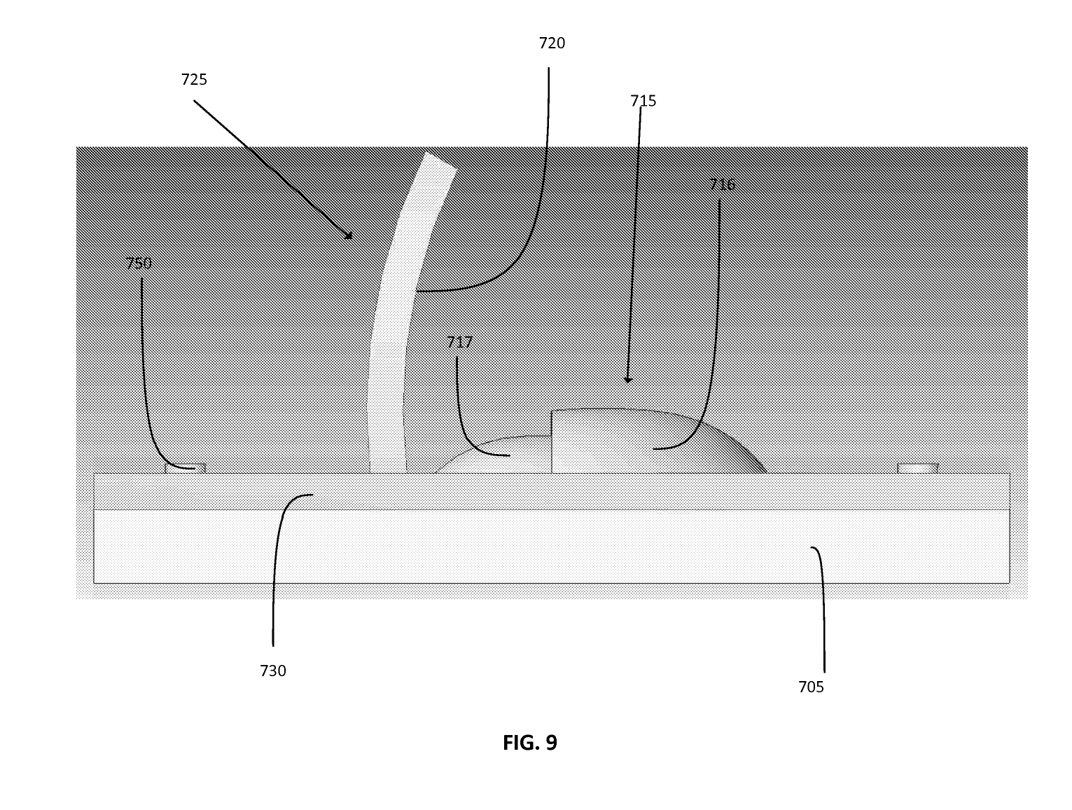

Referring to FIGS. 7 through 9, a third embodiment of the LED lighting unit is illustrated. The third embodiment may share one or more characteristics with the previously described embodiments. The LED lighting unit includes a single reflector 725 and a single optical piece 715. The illustrated embodiment includes an outward facing surface 730 which may share one or more characteristics with outward facing surface 130 of the embodiment illustrated in FIGS. 1 through 3. The optical piece 715 may share one or more characteristics with optical pieces 115 and/or 415 of the previously described embodiment. In some embodiments a plurality of optical pieces 715 may be provided with each being positionable over one or more LEDs. For example, in some embodiments each optical piece 715 may be placed over one of a plurality of LEDs on a circuit board, such as LEDs and/or a circuit board that share one or more characteristics with the circuit board 104 and/or 404 of the previously illustrated embodiments. In some embodiments the optical pieces 715 may be positioned over one or more LEDs attached to another surface. For example, in some embodiments the LEDs may be directly attached to a heatsink and/or an additional circuit board.

The illustrated embodiment includes an optical piece surface 705 which may share one or more characteristics with outward facing surface 105 of the embodiment illustrated in FIGS. 1 through 3. The optical piece 715 may include a first portion 716 and a second portion 717 similar to the first portion 116 and second portion 117 of the previously illustrated embodiment in FIG. 3. The first portion may be configured similarly to the first portion in the previous embodiments and direct light as generally shown by example light ray 301 in FIG. 3. The optical piece 715 may include a second portion that directs light as generally shown by example light ray 300 in FIG. 3. The optical piece 715 may include an LED cavity similar to LED cavity 106 of the previous embodiments on an inner facing side thereof and be positioned and sized to surround at least a portion of a single of a respective LED it is provided over. Alignment protrusions 750 on optical piece surface 705 align with respective alignment receptacles 751 on outward facing surface 730 and may optionally be utilized to achieve accurate alignment of the reflector 725 and the optical piece 715.

The reflector 725 extends upward from and is provided near an opening 735 on the side of the opening 735 opposite the primary illumination direction. In the illustrated embodiment the reflector 725 is formed as a single reflector. In some embodiments the reflector 725 may be part of a cohesive array of reflectors. The reflector 725 has a reflective interior surface 720 that is positioned and shaped to reflect stray light emitted from the optical piece 715 in a direction opposite the desired illumination direction toward the desired illumination direction (e.g., as illustrated by example light ray 301 in FIG. 3). The illustrated reflective interior surface 720 is positioned to intersect light emitted from a corresponding optical piece 715 and reflect the light towards the desired illumination direction. The illustrated interior surface 720 is generally arcuate and oriented to reflect light incident thereon from a respective optical piece 415 toward the desired illumination direction. In some embodiments the interior surface 720 may include a single arcuate face. In some implementations the interior surface 720 may include plurality of planar faces adjoining one another. In some embodiments the reflector 725 may extend at least partially over a portion of optical piece 715. In some embodiments the interior reflective interior surface 720 of the reflector 725 may be vacuum metalized and/or painted to achieve a reflective surface. In some embodiments the side of the reflector 725 opposite the reflective face 720 may be painted with and/or molded out of a flat black material to minimize any light reflection off the outward facing surface.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An LED optical system placeable over top of LEDs, comprising:
a plurality of optical pieces, each of said optical pieces including a free form LED cavity on a first side thereof and a free form protrusion on a second side thereof over said LED cavity, each said LED cavity sized to receive at least a portion of at least one of said LEDs;
wherein each of said optical pieces is configured to direct a first light portion of a light output received from said at least one of said LEDs in a desired illumination range toward a desired illumination direction and to direct a second light portion of said light output in a stray illumination range away from said desired illumination direction, said first light portion being a majority of said light output; and
a reflector array placed over said optical pieces, said reflector array including a plurality of openings each sized to receive at least one of said optical pieces and a plurality of reflectors each extending upward from and provided partially over one of said openings;
wherein each of said reflectors includes a reflective interior surface generally facing said desired illumination direction, each said reflective interior surface provided partially over one of said openings opposite said desired illumination direction and reflecting a majority of said second light portion of said light output transmitted from a corresponding at least one of said optical pieces, said second light portion of said light output reflected generally toward said desired illumination direction.

2. The optical system of claim 1, wherein each of said reflectors is provided partially over a respective at least one of said optical pieces.

3. The optical system of claim 1, wherein the reflector array is a cohesive reflector array that includes an intermediary outward facing surface extending between said plurality of openings.

4. The optical system of claim 3, wherein said intermediary outward facing surface of said cohesive reflector array is low reflectance and substantially black in color.

5. The optical system of claim 1, wherein each of said optical pieces is configured to redirect a majority of said light output generated from a single of said LEDs received within a respective of said LED cavities in an iso-illuminance distribution pattern.

6. The optical system of claim 5, wherein said iso-illuminance distribution pattern includes at least one IES distribution pattern.

7. The optical system of claim 1, wherein each said reflective interior surface is substantially planar.

8. The optical system of claim 1, further comprising a reflective layer having a reflective surface and including a plurality of openings each sized to receive at least one of said LEDs, wherein said plurality of optical pieces are placed atop said reflective layer, and said reflective layer generally faces said plurality of optical pieces.

9. An LED optical system placeable over top of LEDs, comprising:
a plurality of optical pieces each configured for placement over at least one of said LEDs generating an LED light output, said optical pieces including a first portion configured to redirect said LED light output incident thereon in a distribution pattern generally toward a desired illumination direction, and a second portion configured to redirect said LED light output incident thereon in an illumination range away from said desired illumination direction;
a plurality of reflectors, each of said reflectors extending upward from and provided partially over at least one of said optical pieces;
wherein each of said reflectors includes a reflective interior surface, each said reflective interior surface generally facing a corresponding optical piece of said at least one of said optical pieces and positioned opposite said desired illumination direction, each said reflective interior surface reflecting said LED light output transmitted in said illumination range from said corresponding optical piece and redirecting said LED light output incident thereon generally toward said desired illumination direction.

10. The optical system of claim 9, wherein each said reflective interior surface is vacuum metalized.

11. The optical system of claim 9, wherein each of said reflectors is provided partially over said second portion of a respective said at least one of said optical pieces.

12. The optical system of claim 9, wherein each of said reflectors is not provided over said second portion.

13. The optical system of claim 9, wherein said optical pieces form a cohesive optical array, said cohesive optical array including an optical array intermediary outward facing surface extending between said optical pieces.

14. The optical system of claim 13, wherein said plurality of reflectors form a cohesive reflector array, said cohesive reflector array including a plurality of openings each sized to receive at least one of said optical pieces and an intermediary outward facing surface extending between said plurality of openings.

15. The optical system of claim 9, wherein said intermediary outward facing surface of said cohesive reflector array is low reflectance and substantially black in color.

16. An LED lighting unit, comprising:
at least one LED;
an optical piece positioned over said LED and redirecting a majority of light output generated by said LED in an iso-illuminance distribution pattern generally toward a desired illumination direction and redirecting a secondary portion of light output generated by said LED generally away from said desired illumination direction;
at least one reflector piece placed over said optical piece, said reflector piece including an opening sized to receive said optical piece, an outward facing surface peripheral of said opening, and a reflector extending upward from and provided partially over said opening;
wherein said reflector includes a reflective interior surface generally facing said desired illumination direction, said reflective interior surface provided partially over said opening opposite said desired illumination direction and reflecting said secondary portion of light output redirected by said optical piece, said secondary portion reflected by said reflective interior surface generally toward said desired illumination direction.

17. The LED lighting unit of claim 16, wherein each said reflective interior surface is vacuum metalized.

18. The LED lighting unit of claim 17, wherein said outward facing surface is substantially low reflectance.

19. The LED lighting unit of claim 18, wherein said optical piece is part of a cohesive optical array including additional optical pieces

20. The LED lighting unit of claim 16, further comprising an intermediary reflective layer interposed between said LED and said optical piece, said intermediary reflective layer having a reflective surface generally facing said optical piece and including an opening sized to receive said LED.
